(19) United States
(12) Patent Application Publication
(10) Pub. No.: US 2012/0194736 A1
(43) Pub. Date: Aug. 2, 2012

(54) Methods and Apparatus for Interactive Media

(76) Inventors: Charles Dasher, Lawrenceville, GA (US); Bob Forsman, Sugar Hill, GA (US); Chris Phillips, Hartwell, GA (US)

(21) Appl. No.: 13/017,220

(22) Filed: Jan. 31, 2011

(51) Int. Cl. H04N 5/04

(52) U.S. Cl. 348/500; 348/E05.009

(57) ABSTRACT

A user can become involved in an Event presented to the user by a media stream. Suitable motion and location cameras and other sensors capture characteristics information on objects, environments, and people in the Event, and that information enables a virtual representation of the user to become a player in the media stream of the Event. Views are generated that include images or representations of one or more real objects in a real space and representations of viewers and that enable the viewers to interact with other images or representations of the objects. To put it another way, a viewer can interact with a TV broadcast of a sporting event, such as a baseball game, an automobile race, etc.

### TECHNICAL FIELD

This invention relates to electronic information systems, and more particularly to multimedia viewing and gaming systems.

### BACKGROUND

Currently, there are many electronic systems for viewing television (TV) programs and there are many gaming systems for playing video games. TV programs are typically viewed on a device, such as a TV receiver, a computer, and a mobile phone. Video games are typically played on a game console, such as the Wii by Nintendo Co., Kyoto, Japan; the PlayStation 3 by Sony Computer Entertainment Inc.; and the Xbox 360 by Microsoft Corp., Redmond, Wash.

Multiscreen Television is currently being developed that includes video on demand (VOD), linear broadcast TV, and time-shifted TV provided to devices other than the typical TV receiver. Linear broadcast TV is generally a broadcast program of media information presented according to a predefined schedule. Besides a typical TV receiver, Multiscreen TV will also be able to provide media information to video game consoles and other devices, such as Blu-Ray and DVD players, all varieties of computers (e.g., desktop, laptop, netbook, and tablet), and mobile devices, such as “smart” phones.

Currently, there are no systems that can combine a TV program and a game and enable a person to interact virtually in a TV program.

### SUMMARY

In accordance with aspects of this invention, there is provided a method of generating characteristics information for interactive media. The method includes sensing information from an event; extracting, in an electronic signal processor based on the information, characteristics information corresponding to at least one object in the event; time synchronizing the characteristics information with a media stream of the event; generating, based on synchronized characteristics information, a virtual representation of the corresponding at least one object in the event; and displaying the virtual representation and the media stream.

Also in accordance with aspects of this invention, there is provided an apparatus for generating characteristics information for interactive media. The apparatus includes a plurality of sensors configured to capture information from an event; an action capture processor configured to extract, based on the information, characteristics information corresponding to at least one object in the event; a time synchronizer configured to synchronize the characteristics information with a media stream of the event; an electronic processor configured to generate, based on synchronized characteristics information, a virtual representation of the corresponding at least one object in the event; and a display configured to display the virtual representation and the media stream.

Also in accordance with aspects of this invention, there is provided a non-transitory computer-readable medium having stored instructions that, when executed by a computer, cause the computer to carry out a method of generating characteristics information for interactive media. The method includes sensing information from an event; extracting, in an electronic signal processor based on the information, characteristics information corresponding to at least one object in the event; time synchronizing the characteristics information with a media stream of the event; generating, based on synchronized characteristics information, a virtual representation of the corresponding at least one object in the event; and displaying the virtual representation and the media stream.

### BRIEF DESCRIPTION OF THE DRAWINGS

The several objects, features, and advantages of this invention will be understood by reading this description in conjunction with the drawings, in which:

FIG. 1 is a diagram of an interactive media system;

FIG. 2 depicts an encoded information stream and elements of an interactive media system;

FIG. 3A is a flow chart of a method of generating information for interactive media;

FIG. 3B is a flow chart of a method of synchronizing characteristics information and a media stream; and

FIGS. 4A, 4B are block diagrams of an action capture system and time synchronizer, respectively.

### DETAILED DESCRIPTION

Embodiments of this invention enable a user to become involved in an Event presented to the user by a media stream. Suitable motion and location cameras and other sensors capture information on objects, environments, and people in the Event, and that information enables a virtual representation of the user to become a player in the media stream of the Event.

In accordance with this invention, views are generated that include images or representations of one or more real objects in a real space and representations of viewers and that enable the viewers to interact with other images or representations of the objects. To put it another way, a viewer can interact with a TV broadcast of a sporting event, such as a baseball game, an automobile race, etc.

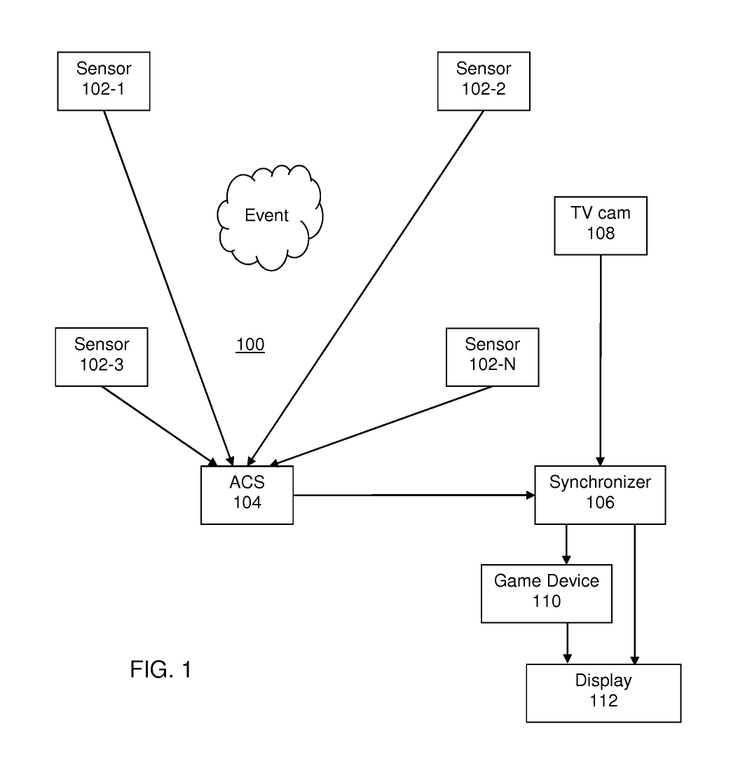

As depicted by FIG. 1, an interactive media system 100 includes a number N of sensors 102-1, 102-2, 102-3, . . . , 102-N that are located with respect to a real Event such that information captured by the sensors is sufficient and suitable for generating characteristics information from the Event. As described in more detail below, the characteristics information enables a suitably programmed electronic processor to generate a realistic virtual representation of one or more objects in the Event, and so the information captured by the N sensors 102 is used by the processor in physics and other algorithms appropriate to generating an interactive virtual representation of the Event. For example, the N sensors 102 can include high-speed, high-resolution video cameras; lidar, radar, and sonar velocity and position sensors; wind velocity sensors; temperature sensors; and any other sensors useful to generating an interactive representation of the Event.

Information from the N sensors 102 is provided to an Action Capture System (ACS) 104 that extracts the characteristics information of the Event and its environment that is appropriate for the purposes of the system 100 as described below. The particular characteristics information extracted depends on the nature of the Event. For example when the Event is a baseball game, it is necessary only to extract characteristics information (in particular, position with respect to time) of the ball when the pitcher throws the ball during the play of the game. At other moments during the play, characteristics information of one or more other objects can be needed for a realistic virtual representation of the play. The ACS 104 applies any suitable motion-capture algorithm to images captured by one or more of the sensors 102 in order to find and track the object or objects of interest in an Event.

In general, a motion-capture algorithm uses differences between successive images, or TV frames, and such differences can be determined based on changes in pixel values between successive images or frames. If the background is static in successive frames, which would be mostly the case for one or more cameras 102 arranged to look down at a baseball game Event, then the changes mostly correspond to a ball travelling through the camera's field of view. If the background is not static, which would be the case for cameras 102 arranged to look horizontally at a baseball game and include people viewing the game, then additional processing of the pixel value changes would be conducted to find and track the object or objects of interest in an Event. Examples of such additional processing include spectral analysis to look for image differences based on the color of an object of interest (e.g., a white baseball, a red automobile, etc.), velocity filtering to look for image differences based on an expected range of speed of an object of interest (e.g., a baseball thrown at 95 miles/hour (153 kilometers/hour), an automobile moving at 200 ml/hr (322 km/hr), etc.), and other processing known in the art. Image changes that do not correspond to an object of the proper color and/or moving at the proper speed can be ignored.

In addition, having at least two sensors/cameras with overlapping fields of view enables correlation of pixels (objects in the fields of views) to help zero-in on an object or objects of interest. A tentative identification of a baseball in an image from a first camera can provide a “stripe of interest” in an image from a second camera in which to focus analysis. In that way, the tentatively identified location in the first camera's image can be applied as a kind of spatial filter to the second camera's image, enabling only that portion of the second camera's image included in, or passed by, the filter to be subjected to object recognition and tracking processing. The use of high-speed cameras (i.e., cameras that generate a large number of images per second, more than the typical 24 or 30 images per second) can provide a more accurate track, and provide more images to reduce the impact of noise and false positives.

The inventors currently believe that substantially any number of objects can be tracked with enough sensors/cameras and ACSs. Of course, the number of sensors/cameras and ACSs in a particular implementation is generally determined by the desired levels of realism and user interaction and by the play of the game and what objects are of interest. Any suitable technique for object tracking that enables extracting desired object characteristics can be used.

An example of object-tracking in TV broadcasts of sporting events is the FoxTrax. In about 1996, FoxTrax was applied in ice hockey as a puck with included battery-powered electronic circuitry that enabled the puck's position to be tracked by infrared (IR) pulse detectors and IR cameras positioned above the ice rink. The puck included IR strobes that enabled the position of the puck to be enhanced against the ice background in TV images of a hockey game.

The inventors currently believe that including IR strobes in a baseball may be problematic because the strobes are likely to be difficult to conceal completely and so would likely change the appearance of a ball. On the other hand, it is believed that a baseball can be suitably tracked based on light reflected by the ball, and the amount of such reflected light can be increased in one or more portions of the electromagnetic spectrum invisible to the human eye, such as IR, but visible to a sensor 102 by including a suitably reflective pattern or patterns on the ball that is also invisible to the human eye.

As an alternative to optically tracking a baseball or similar object, a radio-frequency (RF) transmitter or transponder, such as an active or passive RF identification (RFID) device can be embedded in a baseball. In about 2001, a FoxTrax graphic was used in TV streams of automobile races to point to selected drivers and display the drivers' names, photos, speeds, and other information. Global positioning system (GPS) receivers in the cars and RF telemetry collected position information from the cars.

The ACS 104 can be configured, or programmed, to use any suitable technique to locate and track objects of interest in the fields of view of the image sensors 102, and many suitable techniques are described in the literature, including for example the object detection and tracking techniques described currently on the World Wide Web at visionbib.com/bibliography/motion-f707. For another of many possible particular examples, R. Reppal and H. A. Ochoa, “Radio Telemetry Antenna Design System for Tracking Small and Slow Moving Objects”, Proceedings 42nd Southeastern Symposium on System Theory, IEEE (Mar. 7-9, 2010) discusses radio telemetry techniques for tracking fast- and slow-moving objects, such as wildlife, with directional antennas.

The ACS 104 provides extracted characteristics information of one or more objects to interest and timing data to a time synchronizer 106, which also receives an otherwise conventional TV stream of the Event from a source depicted by a camera 108. The synchronizer 106 is configured to adjust the time data of the extracted characteristics information such that virtual representations of a game and the objects of interest generated by a gaming device 110, such as a Wii, PS3, Xbox 360, computer, mobile phone, etc., can be delivered to a display device 112, such as a TV receiver, in synchrony with the TV stream of the Event that is also delivered to the display device 112 by the synchronizer 106 for Multiscreen TV display.

Among other features, the synchronizer 106 preferably and advantageously is configured to compensate for computation delay of the gaming device 110. The ACS 104 includes timing data along with the extracted characteristics information to represent object locations and other attributes as described above. In a baseball game event for example, the extracted characteristics information is often a location and speed of the ball, and can include an attribute indicating a moment that the ball is crossing the home plate. For a game like baseball, the timing data can be represented in milliseconds.

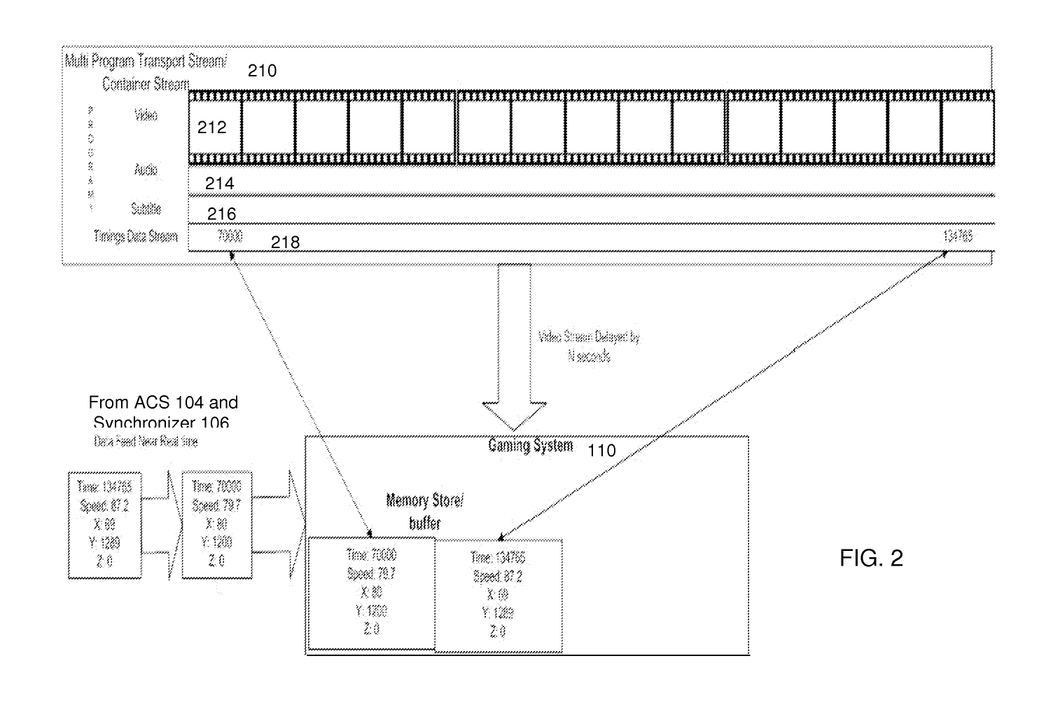

FIG. 2 depicts an encoded media information stream, such as streams provided by the ACS 104 and synchronizer 106 to the gaming device 110 and display 112. It will be appreciated that the encoded stream is typically configured as a stream of containers according to a particular conventional encoding format, such as MPEG-2, MPEG-4, AVC, etc. As depicted in FIG. 2, the information stream 210 typically includes a stream 212 of video frames, a stream 214 of audio information, one or more streams 216 of auxiliary data, such as sub-titles, and a timing data stream 218. The timing data stream conventionally includes a succession of time indices, and the ACS 104 advantageously uses such indices to synchronize the stream and extracted characteristics information of identified objects of interest that it provides in near-real-time to the gaming device 110. The ACS 104 synchronizes the stream and characteristics information by adjusting the timing data included in the characteristics information according to time indices included in the media stream, e.g., by replacing the timing data with the corresponding time indices. The object characteristics information is typically delivered to the gaming device 110 before the corresponding media stream to compensate for the time needed by the gaming device to generate virtual representations based on the characteristics information.

As depicted in FIG. 2, the extracted characteristics information can be stored in a suitable buffer memory in the gaming device 110 for computational and other uses by the device 110, in particular for generating one or more virtual representations of the one or more objects corresponding to the characteristics information. FIG. 2 depicts an example of two groups of object characteristics information, each group comprising a time index (first index=70000 or second index=134765), a position identified by rectangular coordinates (x, y, z) (first position (80, 1200, 0) or second position (69, 1289, 0)), and a speed (first speed=79.7 ml/hr or second speed=87.2 ml/hr). The groups of extracted characteristics information are advantageously synchronized with the information stream 210 through the time indices.

The inventors currently expect that time synchronization of the sensors 102 and camera 108 need be done only once as there is likely to be a substantially fixed time delay between the characteristics information generated by the ACS 104 from Event information collected by the sensors 102 and the media stream provided by the camera 108. Such time synchronization can be implemented as a suitable offset adjustment added to the timing information by either the ACS 104 or time synchronizer 106. The sensors 102 and/or ACS 104 can generate suitable time indices according to the Network Time Protocol (NTP) or use a GPS to determine an accurate local time. The camera 108 and/or synchronizer 106 can associate such a time index with each video frame in the stream 212, and the ACS 104 can associate such time indices with object positions and other extracted characteristics information.

With the media stream broadcast by the camera or source 108 augmented with such time indices, actions by a user of the gaming device 110 can be superposed on actions in the Event, and the gaming device 110 can correlate the user actions with the Event and compute a result for entertainment purposes.

As an alternative, the timing indices used by the ACS 104 and broadcast stream 108 can be independent, and the synchronizer 106 can be configured, or programmed, to transform the ACS timing indices into timing indices equivalent to the broadcast timing indices, or vice versa. In either case, extracted characteristics information and broadcast information can be provided to the gaming device 110 with common timing indices. It will be understood that the gaming device 110 can instead be configured to perform the transformation.

The extracted characteristics information can be used by the ACS 104 and gaming device 110 to compute locations, trajectories, etc. of one or more objects involved in the Event and a game, and the device 110 can modify those locations, trajectories, etc. based on actions by a user of the system 100. In this way, a user viewing the Event program and game on the display 112 can become virtually involved in the program.

It will be understood that the ACS 104, time synchronizer 106, and game device 110 are implemented by one or more suitably programmed electronic processors. Examples of how the system 100 can be used are described below.

In one example, a user is watching a live baseball game (the Event) and playing a video baseball game on a Wii and TV (game device 110 and display 112). If the baseball game is also observed by sensors 102, the user can become involved interactively with the game. For such an Event, N=4 sensors 102 can be provided, including three suitably positioned video cameras and a suitably positioned radar gun or other speed sensor. Two of the cameras and the radar gun enable the ACS 104 to extract characteristics information sufficient to determine the previous and current locations of the ball and to enable the gaming device 110 to compute a projected path of the ball based on one or more actions by the user. The third camera is preferably set up to capture the batter's view of the ball, which is displayed to the user on the display 112. The inventors currently believe that the characteristics information transmitted by the ACS 104 to the synchronizer 106 and gaming device 110 can require as little as 1 kilobyte for each pitch of a baseball game.

The information captured by the sensors 102 is pushed through a suitable communication channel, such as the Internet, to the Wii 110 in near real time and in time synchrony with the video already being displayed on the TV 112. This enables the user to use the Wii and be a virtual batter against a real pitcher in a real baseball game that is currently being shown on the display 112. This also enables friends to play against each other by connecting the user's gaming device 110 to a statistics/competition server 114 through the Internet or another suitable communication channel. Thus, the user can compete against everyone playing or choose a set of friends to compete with.

For another example, the interactive media system 100 can be used in connection with an automobile race. In this example, the user is watching a media program of a live race on a PS3 and notices that the program allows interactive involvement: this race is configured with fifteen sensors 102 that include video cameras and radar guns located around the race track. Ten of the cameras and radar guns enable the ACS 104 to determine the previous locations of all cars on the race track and the current locations of all cars on the track, and enable the PS3 to compute projected paths of all cars on the track. Five stationary cameras are set up to provide an overhead view of the entire race track. The sensor information is pushed to the PS3 in near real time, in synchrony with the media program of the race being displayed on the display device 112. In this way, the user can “become” a driver of a car on the track against real drivers in a real race that is currently being broadcast. In this example, users did not instruct the ACS 104 to track particular cars, but instead, all cars were tracked and the users controlled their own virtual cars through the gaming device 110 in a virtual race with real cars in a real race. It is possible for a user to select an object (car) to track as described above, although this is not required.

Now, a media program viewer is only an outside observer of the action in the program. This invention enables the viewer to become a virtual part of the action.

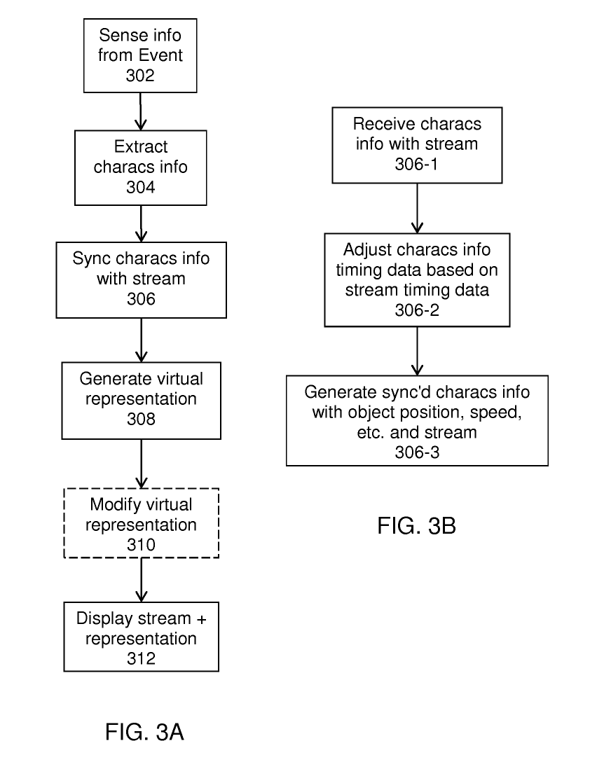

FIG. 3A is a flow chart of a method of generating characteristics information for interactive media that can be implemented by the system 100. The method includes sensing (step 302) information from a real Event. As described above, the sensed information can be images, speeds, etc. collected by one or more sensors 102. The method also includes extracting (step 304) characteristics information corresponding to one or more objects in the Event, in an electronic signal processor based on sensed information. As described above, extracting characteristics information can include identifying and tracking one or more objects of interest in the sensed information and providing corresponding timing information, which can be done by a suitably configured ACS 104. The method further includes time synchronizing (step 306) the extracted characteristics information with a media stream of the Event. As described above, time synchronizing can include adjusting the timing information of the extracted characteristics information such that one or more virtual representations the one or more objects of interest can be delivered in synchrony with the media stream.

The method also includes generating (step 308), based on the synchronized characteristics information, a virtual representation of a corresponding object in the Event. As described above, generating the virtual representation can include generating a trajectory of an object of interest, and such virtual representations can be generated by a gaming device 110, such as a Wii, PS3, Xbox 360, computer, mobile phone, etc. Moreover, a user can interact with the gaming device in a typical way and thereby modify (optional step 310) the virtual representation based on the user's action. The method also includes displaying (step 312) the virtual representation together with the media stream of the Event, for example, by delivering the virtual representation and media stream to a Multiscreen TV display.

FIG. 3B is a flow chart of an example of a method of time synchronizing the extracted characteristics information with a media stream (step 306 in FIG. 3A). Extracted characteristics information, including for example at least one of a position and speed of at least one object of interest in the Event, and a media stream are received (step 306-1), for example by a suitably configured time synchronizer 106. Timing data included in the characteristics information is adjusted according to time indices included in the media stream (step 306-2), and synchronized extracted characteristics information and media stream are produced (step 306-3).

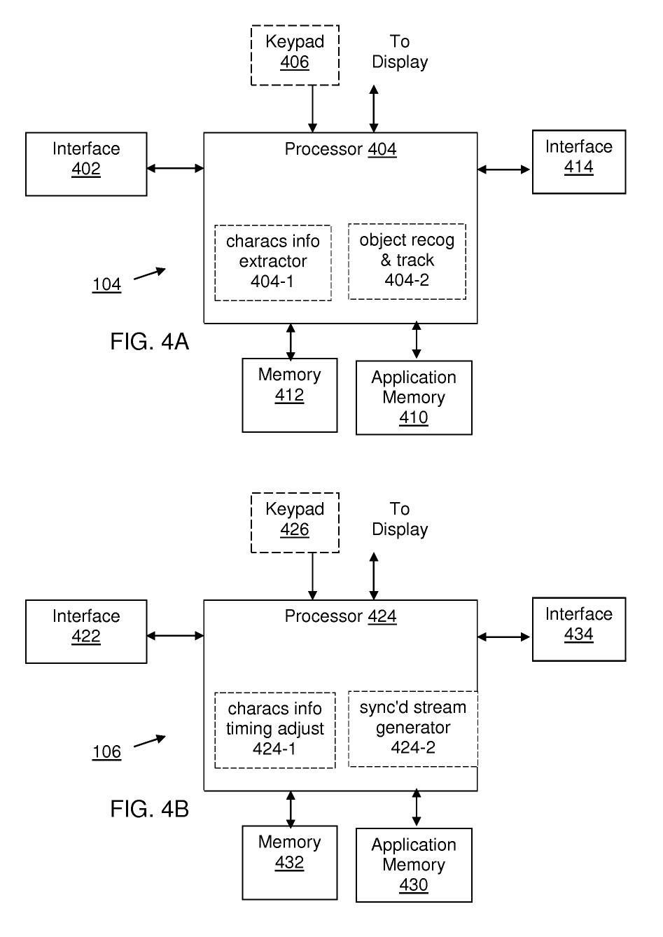

FIG. 4A is a block diagram of a typical ACS 104 for accessing content as described in this application. The ACS 104 includes an interface 402 that is suitable for exchanging electronic signals with one or more of the sensors 102 depicted in FIG. 1. Information carried by those signals is handled by a programmable electronic processor circuit 404, which can include one or more sub-processor circuits, and which executes one or more software modules and applications, including for example a characteristics information extractor 404-1 and an image recognizer and tracker 404-2, to carry out the operations of the ACS 104 described in this application. Input to the ACS 104 can be provided through a keypad, remote control, or other device 406, although it should be understood that operator input and a device 406 are not always necessary. Information can be presented on a suitable display, e.g., the display 112, and if the display has touch-screen capabilities, input to the ACS 104 can be provided through the display. Software applications can be stored in a suitable application memory 410, and the ACS can also download and/or cache desired information in a suitable memory 412. The ACS 104 can also include an interface 414 that can be used to connect to the synchronizer 106 and other components, such as a GPS device, computer, microphone, speaker, etc.

FIG. 4B is a block diagram of a typical time synchronizer 106 for adjusting the time data of extracted characteristics information such that virtual representations of one or more objects of interest can be generated by a gaming device 110. Like the ACS 104 depicted in FIG. 4A, the synchronizer 106 depicted in FIG. 4B includes an interface 422 that is suitable for exchanging electronic signals with the ACS 104. Information carried by those signals is handled by a programmable electronic processor circuit 424, which can include one or more sub-processor circuits, and which executes one or more software modules and applications to carry out the operations of the time synchronizer 106 described in this application. For example, the processor 424 can implement a characteristics timing information adjustor 424-1 and a synchronized characteristics information/media stream generator 424-2 to carry out the operations of the synchronizer 106 described in this application. Input to the synchronizer 106 can be provided through a keypad, remote control, or other device 426, although it should be understood that operator input and a device 426 are not always necessary. Information can be presented on a suitable display, e.g., the display 112, and if the display has touch-screen capabilities, input to the synchronizer 106 can be provided through the display. Software applications can be stored in a suitable application memory 430, and the synchronizer 106 can also download and/or cache desired information in a suitable memory 432. The time synchronizer 106 also includes a suitable interface 434 that can be used to connect the synchronizer 106 to the gaming device 110 and other components.

As described above, the ACS 104 extracts characteristics information of one or more objects of interest in the image streams and other information provided by the sensors 102. The objects of interest can be identified by operation of the programmed processor 404 in the ACS using any suitable object recognition and object tracking techniques that the ACS implements through its software programming, which causes the processor 404, using information in the memories 410, 412, to generate the appropriate characteristics information and send that information to the synchronizer 106 via the interface 404.

It will be appreciated that procedures described above are carried out repetitively as necessary, for example, to respond to the time-varying nature of media programs and Events. It will also be appreciated that the methods and devices described above can be combined and re-arranged in a variety of equivalent ways, and that the methods can be performed by one or more suitably programmed or configured digital signal processors and other known electronic circuits (e.g., discrete logic gates interconnected to perform a specialized function, or application-specific integrated circuits). Many aspects of this invention are described in terms of sequences of actions that can be performed by, for example, elements of a programmable computer system.

Moreover, this invention can additionally be considered to be embodied entirely within any form of computer-readable storage medium having stored therein an appropriate non-transitory set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, or transport the program for use by or in connection with the instruction-execution system, apparatus, or device. The computer-readable medium can be, for example but not limited to, an electronic, magnetic, optical, electromagnetic, infrared, or semiconductor system, apparatus, or device. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

Thus, the invention can be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

What is claimed is:

1. A method of generating characteristics information for interactive media, comprising:
sensing information from an event;
extracting, in an electronic signal processor based on the information, characteristics information corresponding to at least one object in the event;
time synchronizing the characteristics information with a media stream of the event;
generating, based on synchronized characteristics information, a virtual representation of the corresponding at least one object in the event; and
displaying the virtual representation and the media stream.

2. The method of claim 1, wherein time synchronizing comprises adjusting timing data included in the characteristics information according to time indices included in the media stream.

3. The method of claim 2, wherein synchronized characteristics information comprises a time index and at least one of a position and speed of the at least one object in the event.

4. The method of claim 1, wherein generating the virtual representation comprises computing at least one trajectory of the at least one object in the event based on the synchronized characteristics information.

5. The method of claim 4, wherein generating the virtual representation further comprises modifying the at least one trajectory based on an action by a viewer of the virtual representation.

6. An apparatus for generating characteristics information for interactive media, comprising:
a plurality of sensors configured to capture information from an event;
an action capture processor configured to extract, based on the information, characteristics information corresponding to at least one object in the event;
a time synchronizer configured to synchronize the characteristics information with a media stream of the event;
an electronic processor configured to generate, based on synchronized characteristics information, a virtual representation of the corresponding at least one object in the event; and
a display configured to display the virtual representation and the media stream.

7. The apparatus of claim 6, wherein the time synchronizer is configured to adjust timing data included in the characteristics information according to time indices included in the media stream.

8. The apparatus of claim 7, wherein synchronized characteristics information comprises a time index and at least one of a position and speed of the at least one object in the event.

9. The apparatus of claim 6, wherein the electronic processor is configured to generate the virtual representation by computing at least one trajectory of the at least one object in the event based on the synchronized characteristics information.

10. The apparatus of claim 9, wherein the electronic processor is further configured to generate the virtual representation by modifying the at least one trajectory based on an action by a viewer of the virtual representation.

11. A non-transitory computer-readable medium having stored instructions that, when executed by a computer, cause the computer to carry out a method of generating characteristics information for interactive media, wherein the method comprises:
sensing information from an event;
extracting, in an electronic signal processor based on the information, characteristics information corresponding to at least one object in the event;
time synchronizing the characteristics information with a media stream of the event;
generating, based on synchronized characteristics information, a virtual representation of the corresponding at least one object in the event; and
displaying the virtual representation and the media stream.

12. The medium of claim 11, wherein time synchronizing comprises adjusting timing data included in the characteristics information according to time indices included in the media stream.

13. The medium of claim 12, wherein synchronized characteristics information comprises a time index and at least one of a position and speed of the at least one object in the event.

14. The medium of claim 11, wherein generating the virtual representation comprises computing at least one trajectory of the at least one object in the event based on the synchronized characteristics information.

15. The medium of claim 14, wherein generating the virtual representation further comprises modifying the at least one trajectory based on an action by a viewer of the virtual representation.
